(19) United States
(12) Patent Application Publication
(10) Pub. No.: US 2025/0320924 A1
(43) Pub. Date: Oct. 16, 2025

(54) STOP VALVE ASSEMBLY

(71) Applicant: BrassCraft Manufacturing Company, Novi, MI (US)

(72) Inventor: William F. Turnau, III, Canton, MI (US)

(21) Appl. No.: 19/087,714

(22) Filed: Mar. 24, 2025

Related U.S. Application Data
(60) Provisional application No. 63/634,518, filed on Apr. 16, 2024.

(51) Int. Cl. F16K 5/04; F16K 27/12; F16K 31/60

(52) U.S. Cl. CPC F16K 5/0442; F16K 5/0414; F16K 27/12; F16K 31/602

(57) ABSTRACT

A stop valve assembly includes a valve body including a valve body inlet, a valve body outlet, a valve channel between the valve body inlet and the valve body outlet, and a valve port. The assembly also includes a valve carried in the valve body, wherein the valve is selectively rotatable about a rotational axis in the valve body, between an open position and a closed position, a bonnet nut coupled to the valve port to removably retain the valve, and a handle coupled to the valve through the bonnet nut.

### TECHNICAL FIELD

This disclosure relates generally to fluid control products and, more particularly, to stop valve assemblies.

### BACKGROUND

A quarter-turn stop valve assembly typically includes a valve body including an inlet, an outlet, a valve channel between the inlet and outlet, and a valve port, and also including a valve carried in the valve body and having a valve inlet and a valve outlet. The valve is rotatable in the valve body between an open position such that the valve outlet is in fluid communication with the valve body outlet to permit fluid flow through the valve and a closed position such that the valve outlet is out of fluid communication with the valve body outlet to prevent fluid flow through the valve assembly. A stop valve assembly is often located between a fixture or appliance and a wall or floor and is coupled to a fluid supply line emanating out of the wall or floor. One type of stop valve assembly has the inlet and outlet at a right angle to one another, and another type of stop valve has the inlet and outlet coaxially aligned with one another. U.S. Pat. No. 7,036,793 discloses example stop valve assemblies of the angled and straight quarter-turn variety.

But a quarter-turn stop valve assembly cannot be repaired in the field. If the valve assembly is not functioning because of worn seals, the valve assembly must be removed and replaced. This can pose a challenge in situations where a pipe protruding out of a wall or floor is not long enough to facilitate such removal and replacement, thereby requiring a repairperson to attach an adapter to extend the pipe or to cut into the wall or floor so a longer piece of pipe can be added. But cutting into the wall or floor, which may have custom finishes, adds to the difficulty and time to make a repair.

### SUMMARY

In an embodiment, a stop valve assembly includes a valve body including a valve body inlet, a valve body outlet, a valve channel between the valve body inlet and the valve body outlet, and a valve port. The assembly also includes a valve carried in the valve body, wherein the valve is selectively rotatable about a rotational axis in the valve body, between an open position and a closed position, a bonnet nut coupled to the valve port to removably retain the valve, and a handle coupled to the valve through the bonnet nut.

In another embodiment, a stop valve assembly includes a valve housing including a valve body including a valve body inlet, a valve body outlet, a valve channel between the valve body inlet and the valve body outlet, and a valve port. The assembly also includes a valve carried in the valve body, and including a sealing element including a valve inlet, a valve outlet, and a valve passage in communication between the valve inlet and the valve outlet, wherein at least one of the valve inlet or the valve outlet are in selective fluid communication respectively with at least one of the valve body inlet or the valve body outlet. The assembly further includes a spindle coupled to the sealing element and having a base carried between the valve channel and the valve port, and a stem extending from the base through the valve port to facilitate manipulation of the sealing element within the valve body. The valve is selectively rotatable about a rotational axis in the valve body, between an open position such that the valve outlet is in fluid communication with the valve body outlet to permit fluid flow through the valve, and a closed position such that the valve outlet is out of fluid communication with the valve body outlet to prevent fluid flow through the valve. The assembly additionally includes a valve rotation limiter carried at least partially in the valve port of the valve body, a bonnet nut including a bonnet base wall having an aperture through which the stem of the spindle of the valve extends, and a bonnet outer skirt extending away from the bonnet base wall and being threaded to the valve port to removably retain the valve and the valve rotation limiter, and a handle including a handle base wall, a handle outer skirt extending away from the handle base wall, and a handle inner skirt extending away from the handle base wall and coupled to the stem of the spindle of the valve.

### BRIEF DESCRIPTION OF THE DRAWINGS

FIG. 1 is a cross-sectional view according to an illustrative embodiment of a partial-turn stop valve.

FIG. 1A is an enlarged fragmentary portion of FIG. 1.

FIG. 2 is a partially exploded perspective view of the partial-turn stop valve of FIG. 1.

FIG. 3 is a perspective view of the partial-turn stop valve of FIG. 1.

FIG. 4 is a perspective cross-sectional view according to another illustrative embodiment of a partial-turn stop valve, including a unitary valve stem and rotation limiter.

FIG. 5 is a perspective view of the unitary valve stem and rotation limiter of FIG. 4.

FIG. 6 is another perspective view of the unitary valve stem and rotation limiter of FIG. 4.

FIG. 7 is an additional perspective view of the unitary valve stem and rotation limiter of FIG. 4.

### DETAILED DESCRIPTION

In general, valve assemblies, sub-assemblies, and components will be described using one or more examples of illustrative embodiments of a fluid supply quarter-turn stop valve assembly that includes a housing having a valve body with a valve body inlet and a valve body outlet, a rotatable valve between the valve body inlet and the valve body outlet, and a handle connected to the valve. As will be described in greater detail below, the presently disclosed subject matter includes a novel arrangement of components for repairability of a partial-turn stop valve assembly. For example, the presently disclosed subject matter may be used to provide a quarter-turn stop valve assembly that will allow for a field repair to the valve without having to remove the valve body from a pipe, preventing the need to modify piping connected to the valve body. The example embodiments will be described with reference to use with a stop valve assembly of right-angled construction, and with reference to use in household plumbing applications. However, it will be appreciated as the description proceeds that the invention defined by the claims is useful in many different applications and may be implemented in many other embodiments including use of other types of valve assemblies and in commercial and industrial applications too.

As used in herein, the terminology “for example,””e.g., “for instance,” “like,” “such as,” “comprising,” “having,” “including,” and the like, when used with a listing of one or more elements, is to be construed as open-ended, meaning that the listing does not exclude additional elements. As used herein, permissive terms like “may” and “can” are expedients merely to indicate optionality, for instance, of a disclosed embodiment, element, feature, or the like, and should not be construed as rendering indefinite any disclosure herein. Moreover, directional words such as front, rear, top, bottom, upper, lower, radial, circumferential, axial, lateral, longitudinal, vertical, horizontal, transverse, and/or the like are employed by way of example and not necessarily limitation.

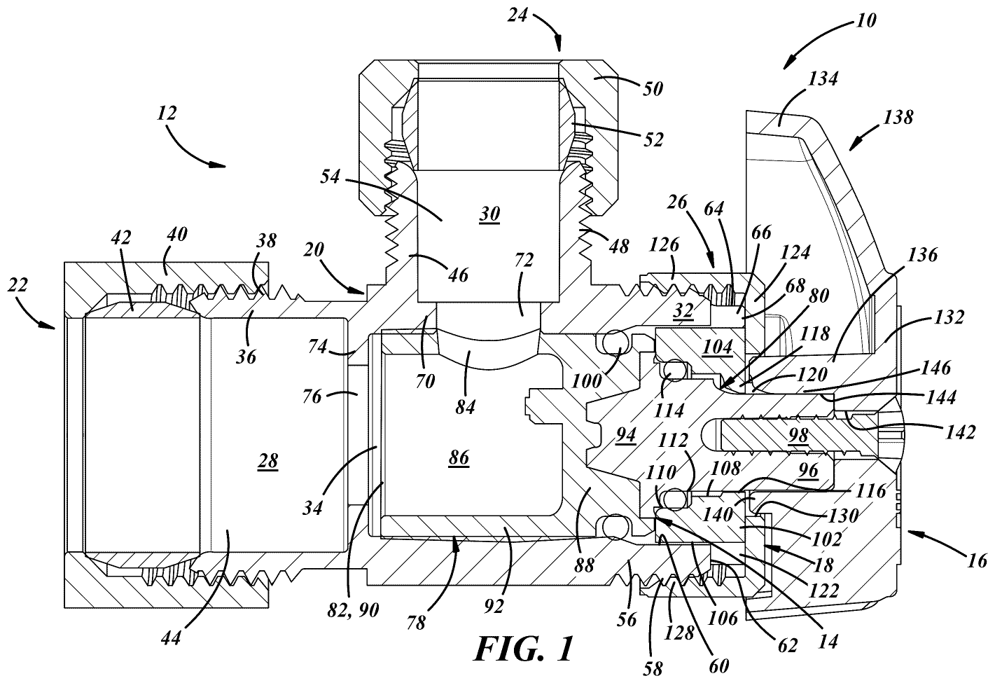

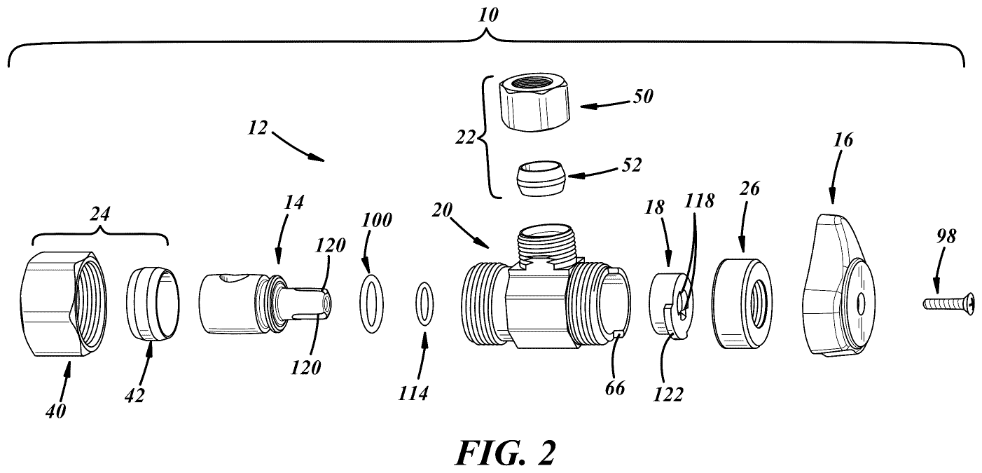

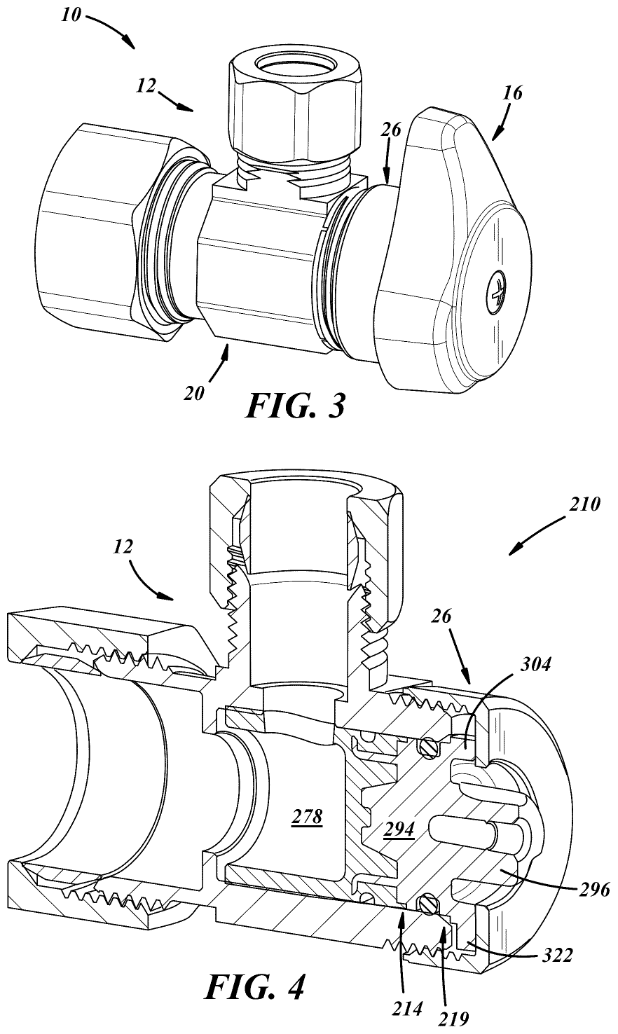

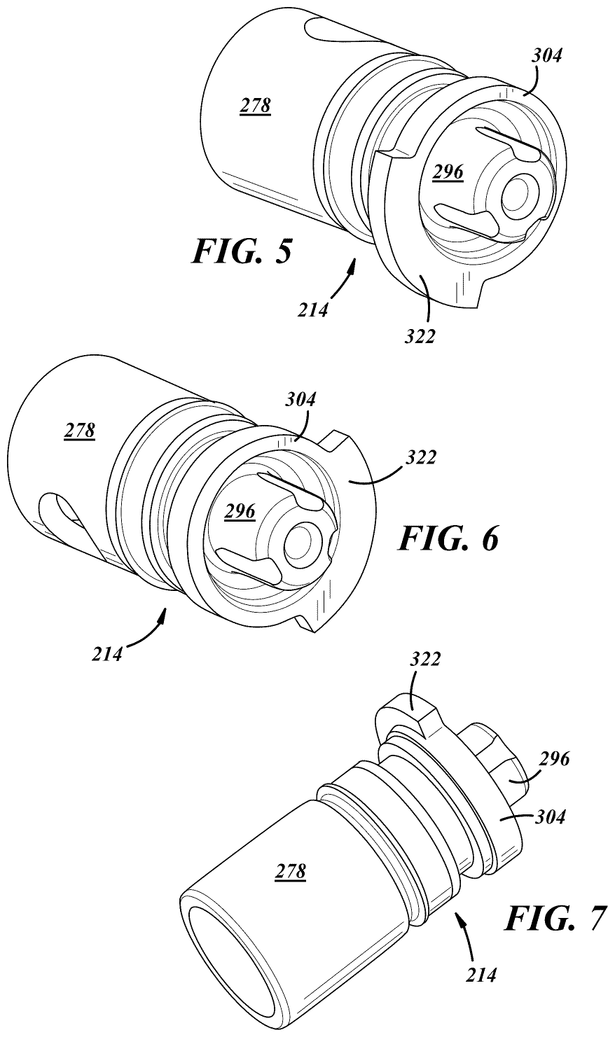

Referring generally to FIGS. 1-3 and, more specifically, to FIG. 1, there is shown an illustrative embodiment of a stop valve assembly 10 that may be a partial-turn stop valve assembly. The stop valve assembly 10 generally includes a valve housing 12, a valve 14 carried by the valve housing 12, and a handle 16 coupled to the valve 14 to facilitate rotation of the valve 14. The valve assembly 10 also may include a valve rotation limiter 18 carried by the valve housing 12. The example assembly illustrated in FIG. 1 is of right-angled, cylindrical, plug valve construction wherein fluid flows in both an axial and radial direction through the valve 14. But those of ordinary skill in the art would recognize that other constructions can be used, including a valve assembly of straight construction, ball valve construction, or of any other orientations, shapes, constructions, or configurations, all of which are contemplated by the scope of the present disclosure and claims.

Now with particular reference now to FIG. 1 (and 1A), the valve housing 12 includes a valve body 20, and also may include an inlet conduit connector 22 and an outlet conduit connector 24 coupled to the valve body 20 to couple inlet and outlet conduits (not shown) to the valve body 20, and a bonnet nut 26 coupled to the valve body 20 to retain the valve 14 and the valve rotation limiter 18 in the valve body 20. The valve body 20 includes a valve body inlet 28, a valve body outlet 30 in selective fluid communication with the valve body inlet 28 by way of the valve 14, a valve port 32, and a valve channel 34 in fluid communication between the valve body inlet 28 and the valve body outlet 30 and open to the valve port 32. The valve body inlet 28 may include a cylindrical wall 36, which may be externally threaded, for instance, with one or more external threads 38, which may include one or more helical threads, bayonet lugs, or the like, for threaded cooperation with an inlet bonnet nut 40 of the inlet conduit connector 22 to compress a compression sleeve 42 into contact with an inlet conduit (not shown). The valve body inlet 28 also may have a smooth internal surface 44 for sliding cooperation with the inlet conduit (not shown). Likewise, the valve body outlet 30 may include a cylindrical wall 46, which may be externally threaded, for instance, with one or more external threads 48, which may include one or more helical threads, bayonet lugs, or the like, for threaded cooperation with an outlet bonnet nut 50 of the outlet conduit connector 24 to compress a compression sleeve 52 into contact with an outlet conduit (not shown). The valve body outlet 30 also may have a smooth internal surface 54 for sliding cooperation with the outlet conduit (not shown). The valve body 20 may be an angle stop valve body, more specifically, a right-angle stop valve body as illustrated. In other embodiments, the valve body 20 may be a straight stop valve body.

The valve port 32 may include a cylindrical wall 56, which may be externally threaded, for instance, with one or more external threads 58, which may include one or more helical threads, bayonet lugs, or the like, for threaded cooperation with the bonnet nut 26. The valve port 32 also may have a smooth internal surface 60 for sliding cooperation with the valve rotation limiter 18, and also may have an axial end surface 62. Additionally, the valve port 32 may include a valve rotation limiting feature to cooperate with the valve rotation limiter 18, and may take the form of a semi-circumferential cylindrical extension 64 extending away the axial end surface 62 and having circumferentially facing stop surfaces 66 and an extension axial end surface 68. In another embodiment, instead of the extension 64, the valve rotation limiting feature may be a circumferentially partial counterbore of the valve port 32 and having circumferentially facing stop surfaces. In the illustrated example, the valve body 20 has a longitudinal rotational axis A extending between the valve body inlet 28 and the valve port 32, and the valve body outlet 30 is transversely disposed with respect to the valve body inlet 28 and the valve port 32. As used herein, the terminology “transversely disposed” may include perpendicularly disposed, as exemplified in FIG. 1, or acutely, obtusely, or otherwise obliquely disposed at any suitable angle with respect to the axis A. The valve body 20 includes any suitable walls, bosses, and/or other housing structure, for example, to cooperate with the valve 14 therein. In particular, the valve body 20 may include a valve seal wall 70 defining an outlet aperture 72 extending therethrough in fluid communication with the valve body outlet 30 and being overlapped by a corresponding portion of the valve 14. Likewise, the valve body 20 may include a valve body inlet wall 74 defining an inlet aperture 76 extending therethrough in fluid communication with the valve 14. The valve body 20 may be composed of metal, for instance, brass, or of plastic, for instance, polyoxymethylene, or of any other materials suitable for and compatible with the particular media flowing through the valve 14.

The valve 14 may include a sealing element 78 that is rotatable about the axis A, and a spindle 80 coupled to the sealing element 78. Accordingly, the valve 14 may be a rotary valve. The valve 14 may be a molded component wherein the sealing element 78 may be co-molded (or co-injection molded) with the spindle 80, or over-molded (or insert-molded) onto the spindle 80, or the sealing element 78 may be molded according to any other suitable molding methods. Any suitable materials can be used in making the valve 14, such as metals, composites, polymeric materials, and other materials suitable for use in stop valve assemblies. In a specific example, the spindle 80 and the sealing element 78 are composed of polymeric materials. More particularly, the spindle 80 may be composed of a thermoplastic material and the sealing element 78 may be composed of an elastomeric material. Even more specifically, the spindle 80 may be composed of nylon, for instance, a glass reinforced nylon resin, and the sealing element 78 may be composed of liquid silicone rubber, for instance, a self-bonding/self-adhesive grade resin that adheres to various polymeric substrates.

The sealing element 78 may be configured, for instance, as a cylindrical plug as illustrated, or as a spherical or semi-spherical ball, or as any other sealing element configuration suitable for use in a stop valve assembly. The sealing element 78 includes a valve inlet 82, a valve outlet 84, and a valve passage 86 in communication between the valve inlet 82 and the valve outlet 84. At least one of the valve inlet 82 or the valve outlet 84 are in selective fluid communication respectively with at least one of the valve body inlet 28 or the valve body outlet 30. In the illustrated embodiment, the sealing element 78 has a base 88, an open inlet end 90, and a wall 92 extending between the open inlet end 90 and the base 88 to at least partially establish the valve passage 86 and having the valve outlet 84 in communication with the valve passage 86 and in selective registration with the outlet aperture 72 of the valve body 20.

The spindle 80 may include a spindle base 94 carried between the valve channel 34 and the valve port 32 and coupled to the base 88 of the sealing element 78 by molding, adhesion, or in any other suitable manner, and a stem 96 extending through the valve port 32 that may be a shaft that may be splined, keyed, flatted, or otherwise provided with a means for positive circumferential coupling to the valve handle to facilitate manipulation of the valve 14 within the valve body 20 and that may be fastened to the handle 16 via a fastener 98 or coupled thereto in any other suitable manner. The valve 14 is selectively rotatable about the axis A in the valve body 20, between an open position such that the valve outlet 84 is in fluid communication with the valve body outlet 30 to permit fluid flow through the valve 14, and a closed position such that the valve outlet 84 is out of fluid communication with the valve body outlet 30 to prevent fluid flow through the valve 14. The valve 14 also may include a seal 100, for instance, an O-ring or other sealing component, disposed between respective seal surfaces of the sealing element 78 and the cylindrical wall 56 of the valve port 32 of the valve body 20. Such sealing components may be composed of elastomeric materials, for instance, PTFE or any other material suitable for the media flowing through the valve assembly 10.

The valve rotation limiter 18 is carried at least partially in the valve port 32 of the valve body 20 and includes a limiter base wall 102, and a cylindrical wall 104 extending away from the limiter base wall 102. The cylindrical wall 104 includes an external surface 106 facing the smooth internal surface 60 of the valve port 32, and an internal passage 108 that may be stepped as shown and, in any case, that may include an internal seal surface 110 facing a corresponding external seal surface 112 of the valve 14, for instance, of the spindle 80 of the valve 14. A seal 114, for instance, an O-ring or other sealing element, may be disposed between the respective seal surfaces 110, 112. The limiter base wall 102 includes an aperture 116 through which the valve 14, for instance, the stem 96 of the spindle 80 of the valve 14, extends outwardly, and also includes a radial engagement feature for coupling to the spindle 80 of the valve 14 against relative rotation therebetween. In the illustrated example, the engagement feature includes a radially inwardly extending key 118 but may include a tooth, spline, or any other suitable projection(s) that engage into a corresponding keyway 120, or in a pocket, spline, or any other suitable relief in the spindle 80, for instance, in the stem 96 of the spindle 80.

The valve rotation limiter 18 also includes a valve rotational limit feature that cooperates with the valve body 20 to limit rotation of the valve 14. For example, the limiter base wall 102 also may include a radially outwardly extending sector portion 122 configured to circumferentially engage against a valve rotational limit feature of the valve body 20, namely, the circumferentially facing stop surfaces 66 of the semi-circumferential cylindrical extension 64 of the valve port 32. Accordingly, the valve rotation limiter 18 rotates with rotation of the valve 14. In another embodiment, although not shown, the radially outwardly extending sector portion 122 may be located and configured to contact with circumferentially facing stop surfaces of a circumferentially partial counterbore of the valve port 32. The valve rotation limiter 18 may be composed of metal, for instance, brass, or of polymermeric material, for instance polypropylene, polycarbonate, ABS, PET, nylon, or any other suitable polymeric material, or of any other material suitable for use with the media flowing through the valve assembly 10.

The bonnet nut 26 is threaded for threaded coupling to the threaded valve port 32, and includes a bonnet base wall 124, and a bonnet outer skirt 126 extending away from the bonnet base wall 124 and having one or more internal threads 128 threaded to the one or more external threads 58 of the valve port 32 to removably retain the valve 14 and the valve rotation limiter 18. The one or more internal threads 128 may include one or more helical threads, bayonet lugs, or the like, for threaded cooperation with the one or more external threads 58 of the valve port 32. The bonnet outer skirt 126 may have a cylindrical outer surface, in contrast to the hexagonal outer surfaces of the other bonnet nuts, for example, to permit clearance to skirt the handle 16 over the bonnet nut 26. But the bonnet nut 26 is not limited to being round and, instead, could be of multi-sided shape such as of hexagonal profile. The bonnet base wall 124 includes an aperture 130 through which the stem 96 of the spindle 80 of the valve 14 extends.

The handle 16 includes a handle base wall 132, a handle outer skirt 134 extending away from the handle base wall 132, and a handle inner skirt 136 extending away from the handle base wall 132 and coupled to the stem 96 of the spindle 80 of the valve 14 through the aperture 130 of the bonnet nut 26. The handle base wall 132 may include an exterior surface carrying any suitable indicia. The handle base wall 132 and outer skirt 134 may be non-cylindrical and including a radially extending projection 138 to facilitate gripping and turning the handle 16. The handle inner skirt 136 may be cylindrical and may include an end wall 140 that may extend into a radial gap between the valve 14 and the bonnet base wall 124. The handle inner skirt 136 also may include a through passage 142 including a counterbore 144 that may be configured to be coupled to the valve 14 against relative rotation therebetween. For example, the handle inner skirt 136 may include a radial engagement feature for coupling to the spindle 80 of the valve 14 against relative rotation therebetween. In the illustrated example, the radial engagement feature includes a radially inwardly extending key 146 but may include a tooth, spline, or any other suitable projection(s) that engage into the corresponding keyway 120 or in a pocket, spline, or any other suitable relief in the spindle 80, for instance, in the stem 96 of the spindle 80.

In use, a supply line (not shown) is inserted into the valve body inlet 28 and may be coupled thereto by brazing or, as shown, by a compression sleeve and a bonnet nut. Likewise, a fixture line (now shown) is inserted into the valve body outlet 30 and may be coupled thereto by brazing or, as shown, by a compression sleeve and a bonnet nut. When a user grasps and turns the handle 16 in a circumferential direction, the valve 14 rotates and opens the outlet aperture 72 to allow fluid to flow into the valve body 20, into and through the valve 14, and out of the valve body 20. When a user desires to repair the valve assembly 10, the user grasps and turns the handle 16 in an opposite circumferential direction, the valve 14 rotates and closes the respective apertures to stop fluid from flowing through the valve body 20 and out the valve body outlet 30. Then the user can turn off a main supply valve or some other valve upstream of the valve assembly 10 to facilitate repair of the valve assembly 10. Thereafter, the user removes the handle 16 from the valve 14, by removing the fastener 98 from the valve stem 96. Subsequently, the user unthreads the bonnet nut from the valve body 20, grasps the valve stem 96 and pulls the valve 14 out of the valve body 20. At that point, the user can replace one or more of the O-rings and/or the valve 14 itself by obtaining one or more of new O-rings and/or a new valve itself and perhaps applying lubricant to the replacement parts and then installing the replacement parts back into the valve port 32. Finally, the user can re-install the rotation limiter 18 in the valve port 32 to the stem 96 of the spindle 80 of the valve 14, thread the bonnet nut 26 back to the valve port 32 of the valve body 20, fasten the handle 16 to the valve 14, and rotate the handle 16 to open the valve assembly 10 and open any upstream valves that were closed.

FIG. 4 shows another illustrative embodiment of a partial-turn stop valve assembly 210. This embodiment is similar in many respects to the embodiment of FIGS. 1-3 and like numerals between the embodiments generally designate like or corresponding elements throughout the several views of the drawing figures. Accordingly, the descriptions of the embodiments are hereby incorporated into one another, and description of subject matter common to the embodiments generally may not be repeated.

The illustrated stop valve assembly 210 is substantially the same as the stop valve assembly 10 of FIGS. 1-3, including the valve housing 12, but instead including a modified valve 214 carried by the valve housing 12 and including a unitary valve stem and rotation limiter 219 and retained to the valve housing 12 by the bonnet nut 26, and omitting the handle 16 for clarity.

The valve 214 may include a sealing element 278 that is rotatable about the axis A and is substantially similar to the sealing element 78 of FIGS. 1-3, and a spindle 280 coupled to the sealing element 278 that is modified compared to the spindle 80 of FIGS. 1-3. In this embodiment, the spindle 280 may include a spindle base 294 and also a stem portion 296 that is part of the unitary valve stem and rotation limiter 219. The valve 214 also may include the seal 100 of the embodiment of FIGS. 1-3, but in this embodiment, that seal 100 is disposed between respective seal surfaces of the spindle 280 and the cylindrical wall 56 of the valve port 32 of the valve body 20. But here the valve 214 omits the additional seal between the valve stem 96 and rotation limiter 18 of the embodiment of FIGS. 1-3 by virtue of the valve stem and rotation limiter 219 being unitary in this embodiment. The unitary valve stem and rotation limiter 219 may be carried at least partially in the valve port 32 of the valve body 20 and includes a cylindrical wall 304 and a valve rotational limit feature that may include a radially outwardly extending sector portion 322 configured to circumferentially engage against the valve rotational limit feature of the valve body 20, namely, the circumferentially facing stop surfaces 66 of the semi-circumferential cylindrical extension 64 of the valve port 32.

Contrary to conventional wisdom that quarter-turn stop valve assemblies are not capable of being field-serviced, the present disclosure provides an economical and inventive solution. Whereas multi-rotation compression stop valve assemblies have been known to be field-serviceable, now quarter-turn stop valve assemblies are serviceable too. Notably, the presently disclosed stop valve assemblies are not multi-rotation compression stop valve assemblies and do not include a threaded valve stem that is advanced and retraced to control fluid flow and that is typical of such assemblies.

Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. As such, many other embodiments, modifications, and equivalents thereto, either exist now or are yet to be discovered and, thus, it is neither intended nor possible to presently describe all such subject matter, which will readily be suggested to persons of ordinary skill in the art in view of the present disclosure. Rather, the present disclosure is intended to embrace all such embodiments and modifications of the subject matter of this application, and equivalents thereto, as fall within the broad scope of the accompanying claims.

1. A stop valve assembly, comprising:
a valve body including
a valve body inlet,
a valve body outlet,
a valve channel between the valve body inlet and the valve body outlet, and
a valve port;
a valve carried in the valve body, wherein the valve is selectively rotatable about a rotational axis in the valve body, between an open position and a closed position;
a bonnet nut coupled to the valve port to removably retain the valve; and
a handle coupled to the valve through the bonnet nut.

2. The stop valve assembly of claim 1, further comprising:
a valve rotation limiter carried at least partially in the valve port of the valve body,
wherein the bonnet nut also removably retains the valve rotation limiter.

3. The stop valve assembly of claim 2, further comprising:
a seal disposed between the valve and the valve rotation limiter.

4. The stop valve assembly of claim 1, further comprising a seal disposed between the valve and the valve port of the valve body.

5. The stop valve assembly of claim 1, wherein the valve body includes a valve rotation limiting feature at the valve port.

6. The stop valve assembly of claim 5, further comprising:
a valve rotation limiter carried at least partially in the valve port of the valve body and cooperative with the valve rotation limiting feature of the valve body.

7. The stop valve assembly of claim 1, wherein the valve includes a sealing element and a spindle having a base coupled to the sealing element and a stem extending away from the base.

8. The stop valve assembly of claim 7, further comprising a valve rotation limiter coupled to the spindle of the valve and a seal located between the valve rotation limiter and the spindle.

9. The stop valve assembly of claim 7, wherein the stem of the spindle is part of a unitary valve stem and rotation limiter that cooperates with the valve body to limit rotation of the valve.

10. A stop valve assembly, comprising:
a valve housing including
a valve body including
a valve body inlet,
a valve body outlet,
a valve channel between the valve body inlet and the valve body outlet, and
a valve port;
a valve carried in the valve body, and including:
a sealing element including
a valve inlet,
a valve outlet, and
a valve passage in communication between the valve inlet and the valve outlet, wherein at least one of the valve inlet or the valve outlet are in selective fluid communication respectively with at least one of the valve body inlet or the valve body outlet; and
a spindle coupled to the sealing element and having:
a base carried between the valve channel and the valve port; and
a stem extending from the base through the valve port to facilitate manipulation of the sealing element within the valve body;
wherein the valve is selectively rotatable about a rotational axis in the valve body, between:
an open position such that the valve outlet is in fluid communication with the valve body outlet to permit fluid flow through the valve, and
a closed position such that the valve outlet is out of fluid communication with the valve body outlet to prevent fluid flow through the valve;
a valve rotation limiter carried at least partially in the valve port of the valve body;
a bonnet nut including
a bonnet base wall having an aperture through which the stem of the spindle of the valve extends; and
a bonnet outer skirt extending away from the bonnet base wall and being threaded to the valve port to removably retain the valve and the valve rotation limiter; and
a handle including
a handle base wall;
a handle outer skirt extending away from the handle base wall; and
a handle inner skirt extending away from the handle base wall and coupled to the stem of the spindle of the valve.

11. The stop valve assembly of claim 10, further comprising a seal between the sealing element of the valve and the valve channel.

12. The stop valve assembly of claim 10, further comprising a seal between the spindle of the valve and the valve rotation limiter.

13. The stop valve assembly of claim 10, further comprising a fastener extending through the handle base wall and threaded into the stem of the spindle of the valve.

14. The stop valve assembly of claim 10, wherein the valve body is an angle stop valve body.

15. The stop valve assembly of claim 10, wherein the valve body is a straight stop valve body.

16. The stop valve assembly of claim 10, wherein the sealing element is molded to the spindle, wherein the spindle is composed of a thermoplastic material and the sealing element is composed of an elastomeric material.

17. The stop valve assembly of claim 10, wherein the spindle is composed of nylon and the sealing element is composed of liquid silicone rubber.

18. The stop valve assembly of claim 10, wherein the stem of the spindle is a shaft.

19. The stop valve assembly of claim 10, wherein the sealing element is a cylindrical plug.
